(19) United States
(12) Patent Application Publication
(10) Pub. No.: US 2012/0044719 A1
(43) Pub. Date: Feb. 23, 2012

(54) CONTROL DEVICE FOR THE VOLTAGE- ABSENT SWITCHING OF A SWITCHING ELEMENT OF A VOLTAGE CONVERTER

(76) Inventors: Alexander Ehret, Nurnberg (DE); Peter Maisel, Nurnberg (DE); Martin Saliternig, Herzogenaurach (DE)

(21) Appl. No.: 13/266,329

(22) PCT Filed: Apr. 22, 2010
(86) PCT No.: PCT/EP2010/055360

§ 371 Date: Oct. 26, 2011

(30) Foreign Application Priority Data
Apr. 27, 2009 (DE) 10 2009 019 016.3

(51) Int. Cl. H02M 3/335

(52) U.S. Cl. 363/17

(57) ABSTRACT

In a control device (28) for the voltage-absent switching of at least one switching element (18-24) of a voltage converter (10), a detection element (30) detects a resonance voltage between the switching element (18-24) and the transformer unit (14). A control unit (34) generates a control signal for the switching element (18-24) as a function of a value of the detected resonance voltage and outputs the control signal to the switching element (18-24). A ZVS path in the control unit switches the switching element at the right time. A bypass path ensures a continuous switching of the switching element if the resonance signal fails to be emitted.

### CROSS-REFERENCE TO RELATED APPLICATIONS

This application is a U.S. National Stage Application of International Application No. PCT/EP2010/055360 filed Apr. 22, 2010, which designates the United States of America, and claims priority to German Application No. 10 2009 019 016.3 filed Apr. 27, 2009, the contents of which are hereby incorporated by reference in their entirety.

### TECHNICAL FIELD

The invention relates to a control device for the zero voltage switching of a switching element of a voltage converter.

The invention furthermore relates to a voltage converter.

The invention furthermore relates to a vehicle [S1].

The invention furthermore relates to a method for controlling zero voltage switching of a switching element of a voltage converter.

The invention furthermore relates to a computer-readable [m2] storage medium.

The invention furthermore relates to a program element for controlling zero voltage switching of a switching element of a voltage converter.

### BACKGROUND

Voltage converters having galvanised insulation usually have a switching unit having at least one switching element, a transformer unit and a rectifying unit. A DC input voltage of the voltage converter is converted to an AC voltage by means of switching elements of the switching unit, the amplitude of said AC voltage being altered by means of the transformer unit. The transformed voltage is forwarded to the rectifying unit in order to convert the transformed signal again into a DC output voltage at a different level.

The switching elements of the switching unit of the voltage converter are usually semiconductor switches in the form of MOSFETs (metal oxide semiconductor field effect transistors) or IGBTs (insulated gate bipolar transistors).

The efficiency of the voltage converter is largely determined by the conduction losses of the switching elements. The switching losses of the switching elements, which are embodied for example as semiconductor switches, have a further, very great influence on the efficiency. In order to minimize these switching losses (switching-on and/or switching-off losses), it is generally known to switch on the switching elements with zero voltage at an instant at which the voltage across the switching element has a zero crossing (“zero voltage switching (ZVS)”). The optimum switching instant of the switching elements therefore brings about a significantly highly efficiency of the voltage converter.

U.S. Pat. No. 6,178,099 B1 discloses a control device for the zero voltage switching of a switching transistor of a series resonant converter in which the switching instant for the switching transistors is determined with the aid of detection of the zero crossing of the current of the switching elements.

However, the known control device has a complex design in order to make it possible to determine the optimum switching instant for zero voltage switching of the switching elements.

### SUMMARY

According to various embodiments, control of zero voltage switching of a switching element of a voltage converter can be configured in a particularly simple manner.

According to an embodiment, a control device for the zero voltage switching of at least one switching element of a voltage converter, wherein the voltage converter has a switching unit having at least the switching element, a transformer unit for transforming a voltage of the switching unit into a transformed voltage, and a rectifying unit for the transformed voltage, may have: a detection element for detecting a resonant voltage between the switching element and the transformer unit; and a control unit for generating a control signal for the switching element in a manner dependent on a value of the detected resonant voltage and for outputting the control signal to the switching element.

According to a further embodiment, the control device may have a comparison element for comparing the detected resonant voltage with a reference voltage, wherein the control unit is designed to generate the control signal for the switching element in a manner dependent on an output signal of the comparison element. According to a further embodiment, the reference voltage can be an input voltage of the voltage converter. According to a further embodiment, the comparison element may have a comparator for comparing the detected resonant voltage with the reference voltage. According to a further embodiment, the control device may have a rectifying element for rectifying the detected resonant voltage. According to a further embodiment, the control device may have a modulation element for modulating the reference voltage. According to a further embodiment, the modulation element has a voltage divider for altering a level of the reference voltage. According to a further embodiment, the control unit may have an element for generating an original control signal, an AND logic combination element for logically combining the original control signal with an input signal of the control unit and an OR logic combination element for logically combining the original control signal with an output signal of the AND logic combination element. According to a further embodiment, the control unit may have an adding element for adding a temporal offset to the original control signal prior to feeding to the AND and/or OR logic combination element. According to a further embodiment, the input signal of the control unit, the original control signal and the control signal for the switching element can be voltages. According to a further embodiment, the switching unit has at least one further switching element, and wherein a control unit as described above is provided for each switching element.

According to another embodiment, a voltage converter may comprise a control device as described above for the zero voltage switching of at least one switching element of the voltage converter.

According to yet another embodiment, a vehicle may comprise a control device as described above for controlling zero voltage switching of at least one switching element of a voltage converter of the vehicle.

According to a further embodiment of the vehicle, the vehicle can be selected from a group consisting of an automobile, a passenger car, a truck, a bus, a train, an aircraft and a ship.

According to yet another embodiment, a method for controlling zero voltage switching of at least one switching element of a voltage converter, wherein the voltage converter has a switching unit having the switching element, a transformer unit for transforming a voltage of the switching unit into a transformed voltage, and a rectifying unit for the transformed voltage, may comprise: detecting a resonant voltage between the switching element and the transformer unit; generating a control signal for the switching element in a manner dependent on a value of the detected resonance signal; and outputting the control signal to the switching element.

According to yet another embodiment, a computer-readable storage medium, in which is stored a program for controlling zero voltage switching of at least one switching element of a voltage converter, wherein the program, if it is executed by a processor, may be designed for carrying out or controlling the method as described above.

According to yet another embodiment, a program element for controlling zero voltage switching of at least one switching element of a voltage converter, if it is executed by a processor, can be designed for carrying out or controlling the method as described above.

### BRIEF DESCRIPTION OF THE DRAWINGS

Further advantages and features of the present invention will become apparent from the following exemplary description of various embodiments. The individual figures in the drawing of this application should be regarded merely as schematic and as not true to scale.

FIG. 1 shows a circuit topology of a signal converter in buck configuration.

FIG. 2 shows a temporal profile of a source-drain voltage and of a drain current of a switching element of the signal converter in FIG. 1.

FIG. 3 shows a temporal profile of a resonant voltage of the signal converter in FIG. 1.

FIG. 4 shows the signal converter in FIG. 1 with a control device in accordance with one exemplary embodiment.

FIGS. 5A and 5B show temporal profiles of the resonant voltage in a non-rectified state and a rectified state of the resonant voltage.

FIG. 6 shows an exerpt from the control device in FIG. 4 with a comparison unit.

FIGS. 7A and 7B show further excerpt from the control device in FIG. 1.

It is pointed out that features or components of different embodiments which are identical or at least functionally identical to the corresponding features or components according to the embodiment are provided with the same reference symbols. In order to avoid unnecessary repetitions, features or components that have already been explained on the basis of a previously described embodiment will no longer be explained in detail at a later juncture.

It is furthermore pointed out that the embodiments described below constitute merely a limited choice of possible embodiment variants. In particular, it is possible to combine the features of individual embodiments with one another in a suitable manner, such that, with the embodiment variants explicitly illustrated here, a large number of different embodiments should be regarded as being disclosed to the person skilled in the art.

### DETAILED DESCRIPTION

In accordance with a first aspect, a control device for the zero voltage switching of at least one switching element of a voltage converter is provided, wherein the voltage converter has a switching unit having at least the switching element, a transformer unit for transforming a voltage of the switching unit into a transformed voltage, and a rectifying unit for the transformed voltage, wherein the control device has a detection element for detecting a resonant voltage between the switching element and the transformer unit, and a control unit for generating a control signal for the switching element in a manner dependent on a value of the detected resonant voltage and for outputting the control signal to the switching element.

In accordance with a further aspect, a voltage converter is provided which has such a control device for the zero voltage switching of at least one switching element of the voltage converter.

In accordance with yet another aspect, a vehicle is provided which has such a control device for controlling zero voltage switching of at least one switching element of a voltage converter of the vehicle [S3].

In accordance with yet another aspect, a method for controlling zero voltage switching of at least one switching element of a voltage converter is provided, wherein the voltage converter has a switching unit having the switching element, a transformer unit for transforming a voltage of the switching unit into a transformed voltage, and a rectifying unit for the transformed voltage, wherein the method comprises detecting a resonant voltage between the switching element and the transformer unit, generating a control signal for the switching element in a manner dependent on a value of the detected resonance signal, and outputting the control signal to the switching element.

In accordance with yet another aspect, a computer-readable [m4] storage medium is provided, in which is stored a program for controlling zero voltage switching of at least one switching element of a voltage converter, wherein the program, if it is executed by a processor, is designed for carrying out or controlling the method for controlling zero voltage switching of at least one switching element of a voltage converter.

In accordance with yet another aspect, a program element for controlling zero voltage switching of at least one switching element of a voltage converter is provided, wherein the program element, if it is executed by a processor, it is designed for carrying out or controlling a method for controlling zero voltage switching of at least one switching element of a voltage converter.

A power supply device can have a control device for the zero voltage switching of at least one switching element of a voltage converter. The power supply device can have a voltage converter. The power supply device can be implementable in a vehicle, in a laptop, in a power station or in a power supply unit or be intended for server applications.

The voltage converter, the vehicle, the method, the computer-readable storage medium and the program element in accordance with the further aspects and also the power supply device described above can have the same effects and advantages as the control device in accordance with one aspect.

In order to ensure optimum driving of the switching element, a resonant oscillation generated by an output capacitance of the switching element and the (leakage) inductance of the transformer unit is utilized, and the resonant voltage is detected by means of a detection element. A control unit, in a manner dependent on a value, for example a maximum of the detected resonant voltage, generates a control signal for the switching element and outputs the control signal, which is then fed to the switching element.

The switching of the switching element at the instant at which the resonant voltage is maximal brings about completely lossless switching of the switching unit, and so the efficiency of the voltage converter is particularly high. Switching of the switching element at an instant at which the resonant voltage has a value not equal to zero, in particular a value between the beginning of a detected resonant voltage peak and an end of a detected resonant voltage peak, constitutes less lossy switching of the switching element in comparison with switching of the switching element at instants at which the resonant voltage is equal to zero, and so these values of the resonant voltage can also be chosen.

Detection points of the resonant voltage can be realized in terms of circuitry between the switching element and the transformer unit. A circuit arrangement for voltage measurement can be provided for detecting the resonant voltage. It may be necessary for the measurement signal to be galvanically isolated, however.

This principle of the temporal driving of the switching element can be used diversely. It can be used, in particular, in the case of actively soft-switched, resonant-switched and quasi-resonant-switched topologies of the voltage converter.

By detecting a resonant voltage, particularly simple driving of the switching element that is to be switched by zero voltage switching is possible, since an intrinsic parameter of the voltage converter can be used for determining the optimum switching instant of the switching element. Furthermore, the efficiency of the voltage converter is increased, since switching losses of the switching elements which occur as a result of temporally unfavorable or incorrect driving of the switching elements can be minimized. The increase in the efficiency of the voltage converter also takes place over the entire power range thereof, in particular a power range of from a few milliwatts to a few kilowatts.

Furthermore, the control device makes it possible to compensate for ageing- and temperature-dictated changes in parameters of components of the voltage converter, in particular the output capacitance of the switching element and the main inductance or leakage inductance of the transformer unit, since the resonant voltage or resonant frequency is dependent on these changes and, consequently, the switching element can always be driven optimally.

The control device likewise brings about a reduction in the costs of the voltage converter, since components, in particular switching elements, with wider parameter tolerances can also be used.

Furthermore, in the case of the voltage converter, it is possible to dispense with separate driving of the switching element when the voltage converter is started, since the temporal control of the switching element is active immediately when the switching element is first switched on, and brings about, for example, automatic tracking of the switching instant of the switching element.

Furthermore, the new determination of the control instant of the switching element in each case compensates for a dependence of the amplitude and of temporal occurrence of the resonant voltage on the input voltage, such that optimum driving of the switching element is made possible even in the case of sudden load changes, particularly in low-load operation.

The control device can have a complex programmable logic component, for example a CPLD (“Complex Programmable Logic Device”) and/or an FPGA (“Field Programmable Gate Array”).

The control device can have a comparison element for comparing the detected resonant voltage with a reference voltage, wherein the control unit is designed to generate a control signal for the switching element in a manner dependent on an output signal of the comparison element.

The comparison element, which is arranged between the detection element and the control unit, serves to determine an instant at which the switching element is intended to be switched. The switching instant chosen can be the instant at which the resonant voltage has a specific threshold value, for example a maximum, which then corresponds to the reference voltage. The provision of a comparison element thus constitutes a particularly simple possibility for determining the optimum switching instant from the detected resonant voltage.

The reference voltage can be an input voltage of the voltage converter, whereby during the comparison it is taken into account that input voltages of different magnitudes lead to resonant voltages of different magnitudes, such that the comparison of the detected resonant voltage with the reference voltage can be carried out in a particularly simple manner.

The comparison element can have a comparator for comparing the detected resonant voltage with the reference voltage. This conventional configuration of the comparison element can be integrated into the voltage converter in a particularly cost-effective manner.

The control device can have a rectifying element for rectifying the detected resonant voltage, such that the processing of the detected resonant voltage can be carried out in a particularly simple manner on the basis of, for example, the absolute amplitude of the resonant voltage. In particular, the comparison of the detected AC resonant voltage with the DC input voltage is effected in a particularly simple manner since the absolute amplitudes of both voltages can be compared directly with one another.

The control device can have a modulation element for modulating the reference voltage, such that the amplitude of the reference voltage is freely selectable. As a result, the switching instant of the switching element can be set in a targeted manner.

The modulation element can have a voltage divider for altering a level of the reference voltage. This conventional configuration of the modulation element can be integrated into the control device in a particularly simple manner, such that the control device can be produced in a particularly cost-effective manner.

The control unit can have an element for generating an original control signal, an AND logic combination element for logically combining the original control signal with an input signal of the control unit and an OR logic combination element for logically combining the original control signal with an output signal of the AND logic combination element.

The input signal of the control unit can be the detected (rectified) resonant voltage or the output voltage of the comparison element.

The control unit is consequently embodied as a logic controller having, as input signal, the detected resonant voltage or, in the case where the comparison element is provided, the output signal of the comparison unit and, as output signal, the control signal for the switching element. The control unit comprises two paths, namely a bypass path and a path for the zero voltage switching of the switching element (ZVS path). The bypass path is formed by the element for generating an original control signal and the OR logic combination element, while the ZVS path is formed by the element for generating an original control signal and the AND logic combination element, which logically combines the input signal of the control unit with the original control signal. In the case of detection of the resonance signal, the detected signal can be passed via the ZVS path, such that the switching element can be switched at the correct instant. In the case where the resonance signal fails to appear, the bypass path generates a control signal for the switching element, such that temporally continuous switching of the switching element is made possible.

The control unit can be, for example, a programmable logic component, for example a CPLD (“Complex Programmable Logic Device”) or an FPGA (“Field Programmable Gate Array”).

The control unit can have an adding element for adding a temporal offset to the original control signal prior to feeding to the AND and/or OR logic combination element. The adding element can add, for example, a dead time to the original control signal, in order to achieve a temporal shift in the control signal for the switching element. In this case, the dead time can be a minimum permissible dead time which still ensures that no bridge short-circuits occur in the voltage converter as a result of temporally incorrect switching of the switching element.

The input signal of the control unit, the original control signal and the control signal for the switching element can be voltages, whereby particularly simple signal processing is made possible.

The switching unit can have at least one further switching element, wherein the control unit described above can be provided for each switching element.

The control units for each switching element can also be realized in a common switching unit having, for example, inputs for the detected resonant voltage or the output signal of the comparison unit and outputs for switching signals for each switching element. The switching unit enables simultaneous driving of a plurality of switching elements, as a result of which the switching device is embodied in a particularly simple manner.

It is pointed out that embodiments have been described with reference to different subjects. In particular, some embodiments are described by device embodiments and other embodiments are described by method embodiments. However, it will become immediately clear to the person skilled in the art upon reading this application that, unless explicitly indicated otherwise, in addition to a combination of features which are associated with one type of subject, any desired combination of features which are associated with different types of subjects is also possible.

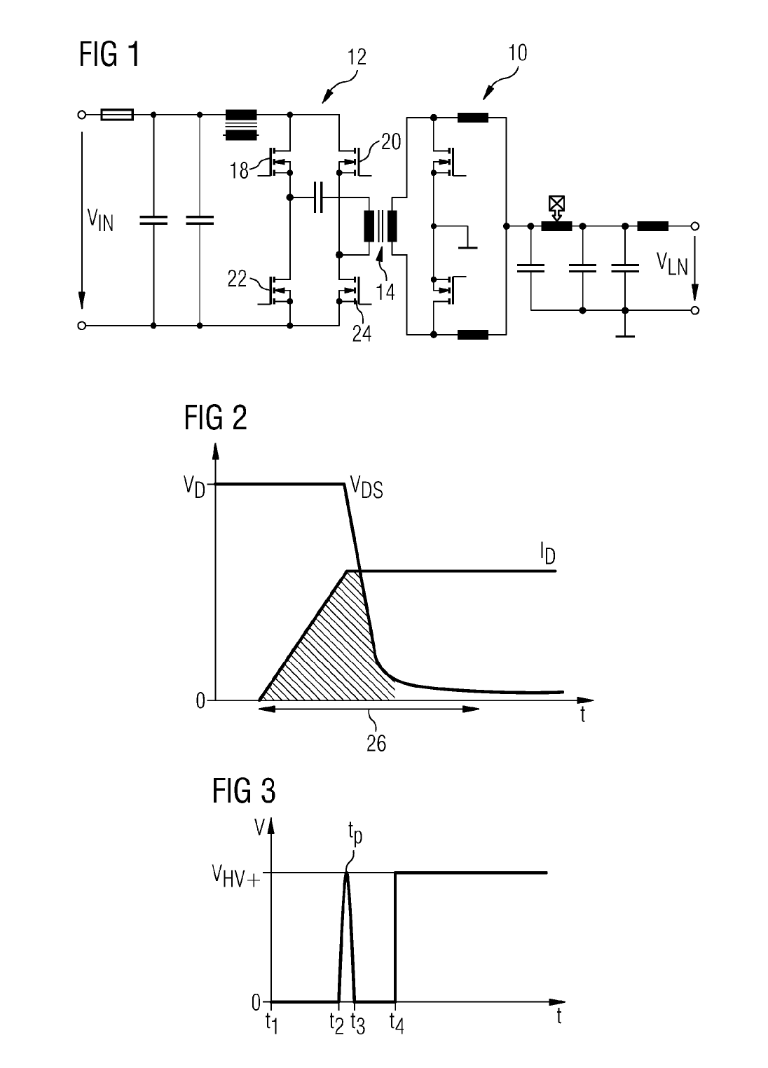

FIG. 1 shows a signal converter 10 in the form of a voltage converter, which has a switching unit 12, a transformer unit and a rectifying unit 16. The signal converter 10 is operated in buck configuration, such that a DC input voltage V_{HV} is reduced to an DC output voltage V_{LV}.

The switching unit 12 has four switching elements 18-24 in full-bridge topology, which are embodied as field effect transistors. In order to increase an efficiency of the signal converter 10, the transistors 18-24 are switched by zero voltage switching. In this case, the switch-on instant of the transistors 18-24 is chosen such that a loss in each transistor 18-24, which results as the product of a drain current I_{D} multiplied by a source-drain voltage V_{DS} of the transistor 18-24, becomes minimal (FIG. 2). In this case, the optimum driving instant of the transistor 18-24 is an instant of a switch-on phase 26 of the transistor 18-24.

This optimum switch-on instant of the transistor 18-24 corresponds to an instant t_{P} at which an amplitude of a resonant voltage is maximal, which is brought about by a resonant circuit formed by an output capacitance of the transistor 18-24 and a (leakage) inductance of the transformer unit 14 (FIG. 3). The switching-on of the transistor 18-24 can also be effected in a time period [t₂-t₃] in which a resonant voltage peak occurs. In the ranges t₂<t<t_{P} and t_{P}<t<t₃, the switching-on of the transistor 18-24 is not effected in a lossless fashion. However, the conduction losses of the transistors 18-24 are lower than when the transistors 18-24 are switched on in time ranges t₁<t<t₂ and t₃<t<t₄.

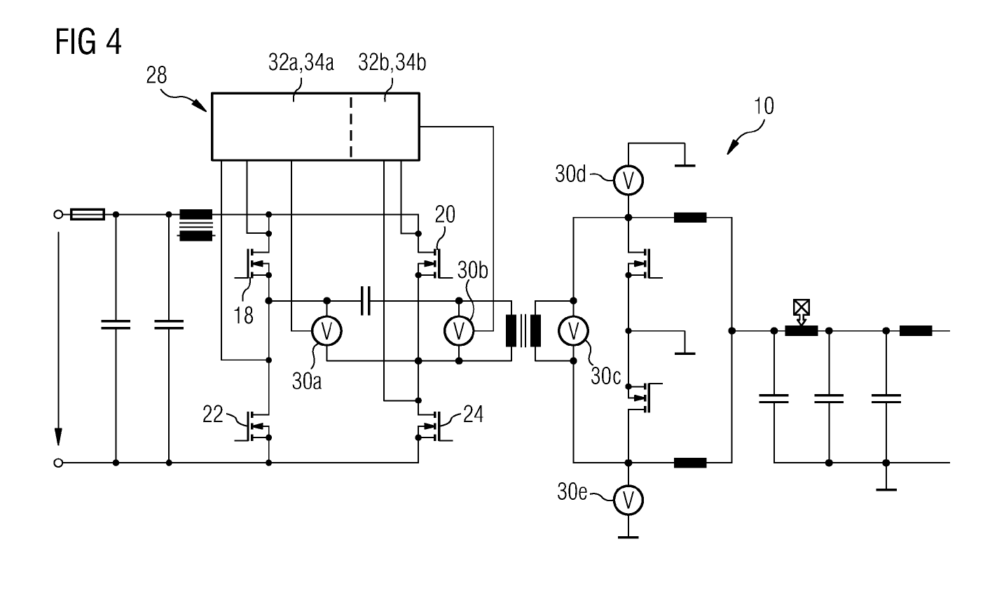

In order to choose the optimum switch-on instant of the transistors 18-24, the signal converter 10 has a control device 28 as illustrated in FIG. 4. The control device 28 detects a maximum of the resonant voltage and uses the associated time information to drive the transistor 18-24.

In order to detect the maximum of the resonant voltage, the control device 28 has a detection element 30a, b and on the secondary side a detection element 30c, d, e for detecting the resonant voltage, a comparison element 32a, b and also a control unit 34a, b. The detection element 30a, b and on the secondary side 30c, d, e detects the resonant voltage in the resonant circuit formed between the transistors 18-24 and the transformer unit 14. As illustrated in FIG. 4, the detection element 30a can be connected in parallel with a connecting line between the transistors 18, 22 and the transformer unit 14. The detection element 30b is connected in parallel between a connecting line between the transistors 20, 24 and the transformer unit 14. The detection element 30c is directly connected to a secondary side of the transformer unit 14. The detection elements 30d, e are connected between ground and transformer unit 14; here it is necessary to use both measurement points for the complete detection of the resonant voltage. The detection element 30a, b and on the secondary side 30c, d, e is illustrated here as a customary voltmeter, by way of example.

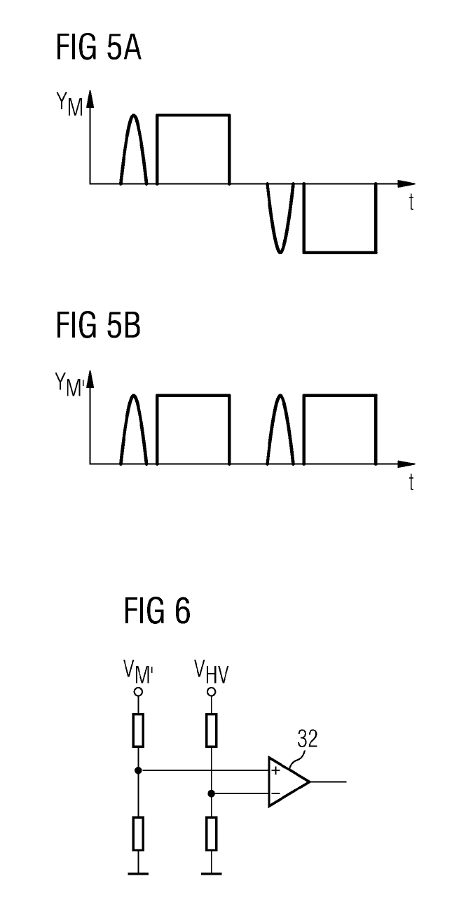

An output of the detection element 30a, b and on the secondary side 30c, d, 3e is connected to a rectifying unit (not illustrated) in order to rectify the detected measurement voltage V_{M} and to convert it into a further voltage V_{M′}, (FIGS. 5A and 5B). The rectifying unit is connected to the comparison unit 32 (FIG. 6). A reference voltage, here the input voltage V_{HV} of the signal converter 10, can be fed via a further input of the comparison element 32.

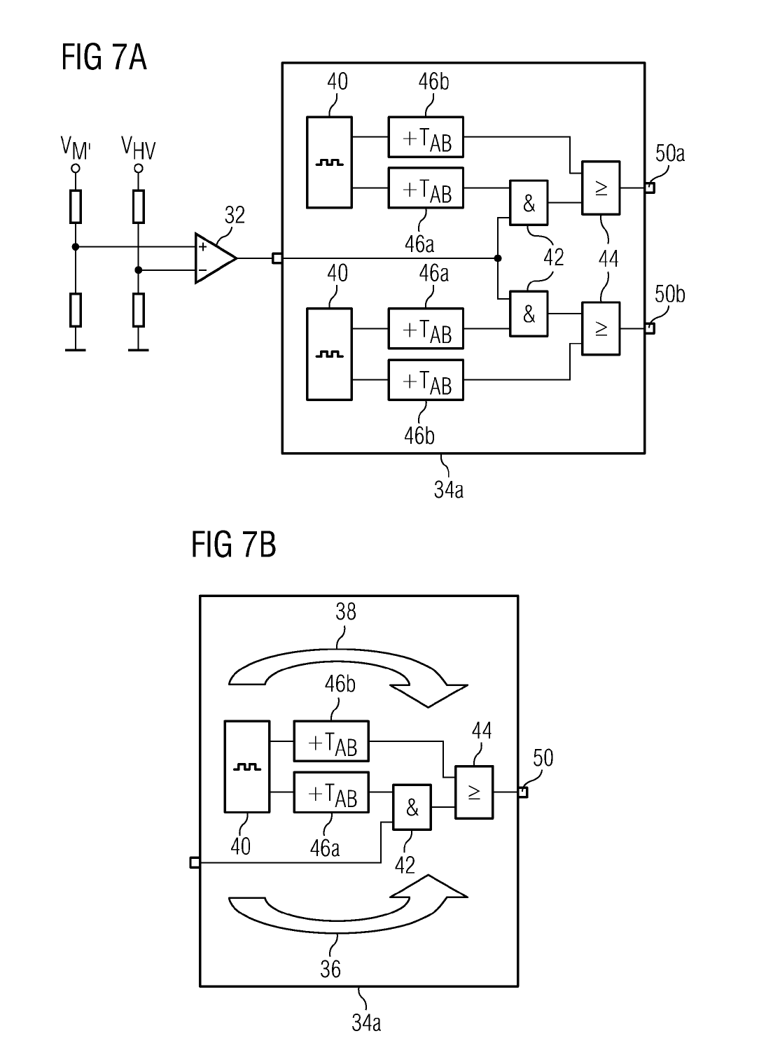

An output of the comparison unit 32a, b is connected to the control unit 34a, b, which is illustrated by way of example in FIGS. 7A and 7B for 2 transistors 18-24.

Referring to FIG. 7B, the control unit 34a has for each transistor 18-24 a path for the zero voltage switching of the transistor 18-24, the ZVS path 36, and also a bypass path 38. For each transistor 18-24, the control unit 34 has an element for generating an original control signal, an AND logic combination element 42 and also an OR logic combination element 44. The AND logic combination element 42 and also the OR logic combination element 44 are logic switching elements. Furthermore, adding elements 46a, b are provided between the element 40 for generating the original control signal and the AND and OR logic combination elements 42, 44. The ZVS path 36 of a transistor 18-24 is formed by the element 40 for generating the original control signal, the adding device 46a, the AND logic combination element 42 and the OR logic combination element 44. The bypass path 38 is formed by the element 40 for generating the original control signal, the adding element 46b and the OR logic combination element 44. The OR logic combination element connects the ZVS path 36 to the bypass path 38. Furthermore, an output 50 for outputting the generated control signals for the transistors 18-24 is present for each transistor 18-24.

During operation of the signal converter 10, the resonant voltage V_{M} is measured as a measurement signal by means of the detection element 30a, 30b. By means of the rectifying element, the measurement signal V_{M} is converted into a rectified measurement signal V_{M′}. The rectified measurement signal V^{M′} is compared with the input voltage V_{HV} of the signal converter 10 in the comparison element 32a, b. In the case where the measurement signal V^{M′} corresponds to the input voltage V_{HV}, an output voltage of the comparison element 32 is output to the control unit 34a, b. The output voltage of the comparison element 32 is fed to the AND logic combination element 42a, b. Furthermore, an original control signal is generated by the element 40 for generating the original control signal and is fed to the AND logic combination element 42 via the adding element 46, which adds a minimum dead time T_{AB} to the original control signal. At the same time, in the bypass path 38, the original control signal is generated by means of the element 40 for generating the original control signal, a maximum dead time T_{AB} is added there by means of the adding element 46b, and the signal is fed to the OR logic combination element 44.

The OR logic combination element 44 connects the ZVS path 36 to the bypass path 38 and here fulfills the task of allocating the respectively required drive signal for the transistor 18-24. Since, in the case of resonance detection, the signal in the ZVS path 36 is present before the signal from the bypass path 38, the transistor 18-24 is switched on at the instant t_{P} of the resonant voltage. Even in the case of sudden load changes or other great changes during the operation of the signal converter 10, the bypass path 38 is useful since it can compensate for disturbances or absence of the resonant voltage.

What is claimed is:

1. A control device for the zero voltage switching of at least one switching element of a voltage converter, wherein the voltage converter has a switching unit having at least the switching element, a transformer unit for transforming a voltage of the switching unit into a transformed voltage, and a rectifying unit for the transformed voltage, the control device comprising:
a detection element for detecting a resonant voltage between the switching element and the transformer unit; and
a control unit for generating a control signal for the switching element in a manner dependent on a value of the detected resonant voltage and for outputting the control signal to the switching element.

2. The control device according to claim 1,
wherein the control device has a comparison element for comparing the detected resonant voltage with a reference voltage, wherein the control unit is designed to generate the control signal for the switching element in a manner dependent on an output signal of the comparison element.

3. The control device according to claim 2,
wherein the reference voltage is an input voltage of the voltage converter.

4. The control device according to claim 2,
wherein the comparison element has a comparator for comparing the detected resonant voltage with the reference voltage.

5. The control device according to claim 1,
wherein the control device has a rectifying element for rectifying the detected resonant voltage.

6. The control device according to claim 2,
wherein the control device has a modulation element for modulating the reference voltage.

7. The control device according to claim 6,
wherein the modulation element has a voltage divider for altering a level of the reference voltage.

8. The control device according to claim 1,
wherein the control unit has an element for generating an original control signal, an AND logic combination element for logically combining the original control signal with an input signal of the control unit and an OR∘logic combination element for logically combining the original control signal with an output signal of the AND logic combination element.

9. The control device according to claim 8,
wherein the control unit has an adding element for adding a temporal offset to the original control signal prior to feeding to at least one of the AND and OR logic combination element.

10. The control device according to claim 8,
wherein the input signal of the control unit, the original control signal and the control signal for the switching element are voltages.

11. The control device according to claim 1,
wherein the switching unit has at least one further switching element, and wherein a control unit comprising an element for generating an original control signal, an AND logic combination element for logically combining the original control signal with an input signal of the control unit and an OR logic combination element for logically combining the original control signal with an output signal of the AND logic combination element is provided for each switching element.

12. A voltage converter, comprising a control device comprising a detection element for detecting a resonant voltage between the switching element and the transformer unit; and a control unit for generating a control signal for the switching element in a manner dependent on a value of the detected resonant voltage and for outputting the control signal to the switching element, wherein the control device is configured for the zero voltage switching of at least one switching element of the voltage converter.

13. A vehicle, comprising a control device comprising a detection element for detecting a resonant voltage between the switching element and the transformer unit; and a control unit for generating a control signal for the switching element in a manner dependent on a value of the detected resonant voltage and for outputting the control signal to the switching element, wherein the control device is configured for controlling zero voltage switching of at least one switching element of a voltage converter of the vehicle.

14. The vehicle according to claim 13,
wherein the vehicle is selected from a group consisting of an automobile, a passenger car, a truck, a bus, a train, an aircraft and a ship.

15. A method for controlling zero voltage switching of at least one switching element of a voltage converter, wherein the voltage converter has a switching unit having the switching element, a transformer unit for transforming a voltage of the switching unit into a transformed voltage, and a rectifying unit for the transformed voltage, wherein the method comprises:
detecting a resonant voltage between the switching element and the transformer unit;
generating a control signal for the switching element in a manner dependent on a value of the detected resonance signal; and
outputting the control signal to the switching element.

16. A computer-readable storage medium, in which is stored a program for controlling zero voltage switching of at least one switching element of a voltage converter, wherein the program, if it is executed by a processor, performs the steps of:
detecting a resonant voltage between the at least one switching element and a transformer unit;
generating a control signal for the at least one switching element in a manner dependent on a value of the detected resonance signal; and
outputting the control signal to the switching element.

17. (canceled)

18. The voltage converter according to claim 12,
wherein the control device has a comparison element for comparing the detected resonant voltage with a reference voltage, wherein the control unit is designed to generate the control signal for the switching element in a manner dependent on an output signal of the comparison element.

19. The voltage converter according to claim 18,
wherein the reference voltage is an input voltage of the voltage converter.

20. The voltage converter according to claim 18,
wherein the comparison element has a comparator for comparing the detected resonant voltage with the reference voltage.
